(19) United States
(12) Patent Application Publication
(10) Pub. No.: US 2014/0111716 A1
(43) Pub. Date: Apr. 24, 2014

(54) LIQUID CRYSTAL DISPLAY PANEL

(71) Applicant: AU OPTRONICS CORPORATION, Hsinchu (TW)

(72) Inventors: Sau-Wen Tsao, Taipei City (TW); Mei-Ju Lu, Kaohsiung City (TW); Cho-Yan Chen, Taichung City (TW); Tien-Lun Ting, Taichung City (TW)

(73) Assignee: AU OPTRONICS CORPORATION, Hsinchu (TW)

(21) Appl. No.: 13/781,754

(22) Filed: Mar. 1, 2013

(30) Foreign Application Priority Data
Oct. 22, 2012 (TW) 101138953

(51) Int. Cl. G02F 1/1343; G02F 1/133

(52) U.S. Cl. CPC G02F 1/134336; G02F 1/13306
USPC 349/33; 349/143; 349/123

(57) ABSTRACT

A liquid crystal display panel having pixel regions includes a light shielding layer having opening regions corresponding to the pixel regions, first pixel electrodes and second pixel electrodes. Each first pixel electrode includes strip first pixel electrode patterns. Each second pixel electrode includes strip second pixel electrode patterns. Each opening region includes sub regions. Each of the strip first pixel electrode patterns and its neighboring strip second pixel electrode pattern in each of the sub regions are separated by an electrode spacing. Electrode spacings in different sub regions are different. An area of all the sub regions with the electrode spacings less than or equal to 12 micrometers accounts for less than or equal to 35% area of each opening region. An area of the other sub regions with the electrode spacings greater than 12 micrometers accounts for more than or equal to 65% area of each opening region.

### CROSS-REFERENCE TO RELATED APPLICATION

This application claims the priority benefit of Taiwan application serial no. 101138953, filed on Oct. 22, 2012. The entirety of the above-mentioned patent application is hereby incorporated by reference herein and made a part of this specification.

### BACKGROUND OF THE INVENTION

1. Field of the Invention

The present invention generally relates to a display panel, and more particularly, to a liquid crystal display (LCD) panel.

2. Description of Related Art

Nowadays, the market demands the liquid crystal display (LCD) panel to develop its functions towards high contrast ratio, no gray scale inversion, little color shift, high luminance, full color, high color saturation, high response speed and wide viewing angle. Currently, the technologies capable of fulfilling the demands of wide viewing angle include the twist nematic (TN) LCD panel having a wide viewing film, the in-plane switching (IPS) LCD panel, the fringe field switching (FFS) LCD panel and the multi-domain vertically aligned (MVA) LCD panel.

Although the LCD as listed above may achieve a wide viewing angle effect, problems associated with color shift or color washout still leave much room for improvement. The so-called color shift or color washout indicates that viewers see images of various color gray scales when viewing the images displayed on a liquid crystal display from different viewing angles. For example, if viewers see images displayed on a liquid crystal display from a more slanting angle (i.e., 60 degrees), a color gray scale of images that viewers watch is lighter than a color gray scale of images when viewers watch from a normal angle (i.e., 90 degrees).

In related art, parameters such as D value, Oblique Local Gamma Distortion (OLGD) value and Tone Rendering Distortion Index (TRDI) may be applied to evaluate displaying effects of the LCD panel. The formula of D value is defined as follows.

$$D ( θ , ϕ ) = {〈 \frac{\vert Δ {B}_{i , j ( on - axis )} - Δ {B}_{i , j ( off - axis ) , θ , φ} \vert}{Δ {B}_{i , j ( on - axis )}} 〉}_{i , j = 0 \sim 255}$$

In other words, the formula of D value is consisting of the following steps: first, computing an absolute value from a value obtained by subtracting “a brightness difference between ith and jth grey levels at on-axis viewing direction” with “a brightness difference between ith and jth grey levels at off-axis viewing direction”; next, computing a resulting value by dividing said absolute value with “the brightness difference between ith and jth grey levels at on-axis viewing direction”; lastly, D value is obtained by calculating an average value for all cases of said resulting value within a range from ith to jth grey levels, in which i and j are respectively an integer from 0 to 255. (referring to “Super PVA Sets New State-of-the-Art for LCD-TV”, SID 2004 International Symposium Digest of Technical Papers).

The formula of OLGD value is defined as follows.

$$O L G D = \sqrt{\frac{{\sum }_{i = 32}^{192} {( {LG}_{2.2} ( i ) - {LG}_{off - axis} ( i ) )}^{2}}{192 - 32 + 1}}$$

In other words, the formula of OLGD value is consisting of the following steps: first, computing a squared value from a value obtained by subtracting “a value of a local gamma on ith stage at on-axis viewing direction” with “a value of a local gamma on ith stage at off-axis viewing direction”; next, computing a sum value for all cases of said squared value with i ranged from 32 to 192; lastly, computing a square root after dividing said sum value with “192−32+1”.

The formula of TRDI value is defined as: k⁻×D⁻+k⁺×D⁺ (referring to “Assessment of Image Quality Degraded by Tone Rendering Distortion” JDT 2011), in which D⁻ is a negative deformation and D⁺ is a positive deformation. The formulas of D⁻ and D⁺ are defined as follows:

D⁻= [symbol] d⁻(i,j) [symbol] _{i,j} D+= [symbol] d⁺(i,j) [symbol] _{i,j}

In other words, D⁻ is an average value of a sum value for all cases of d⁻(i,j) and D⁺ is an average value of a sum value for all cases of d⁺(i,j), in which i and j are respectively an integer from 0 to 255. The formulas of d⁻(i,j) and d⁺(i,j) are defined as follows:

$${d}^{-} ( i , j ) = \frac{Δ {L}_{TS ( i , j )}^{*} - Δ {L}_{TD ( i , j )}^{*}}{Δ {L}_{TS ( i , j )}^{*}}$$

$${d}^{+} ( i , j ) = \frac{Δ {L}_{TD ( i , j )}^{*} - Δ {L}_{TS ( i , j )}^{*}}{Δ {L}_{TD ( i , j )}^{*}}$$

In other words, d⁻(i,j) is computed by dividing a value, obtained by subtracting “the brightness difference of the original image between i^{th} and j^{th} grey levels” with “a brightness difference of a distorted image between i^{th} and j^{th} grey levels”, by a value of “a brightness difference of an original image between i^{th} and j^{th} grey levels”, in which d⁻(i,j) is 0 when “the brightness difference of the original image between i^{th} and j^{th} grey levels” is smaller than “the brightness difference of the distorted image between i^{th} and j^{th} grey levels”. On the other hand, d⁺(i,j) is computed by dividing a value, obtained by subtracting “the brightness difference of the distorted image between i^{th} and j^{th} grey levels” with “the brightness difference of the original image between i^{th} and j^{th} grey levels”, by a value of “the brightness difference of the distorted image between i^{th} and j^{th} grey levels”, in which d⁺(i,j) is 0 when “the brightness difference of the original image between i^{th} and j^{th} grey levels” is greater than “the brightness difference of the distorted image between i^{th} and j^{th} grey levels”.

### SUMMARY OF THE INVENTION

The invention is directed to a design of a LCD panel for enabling the LCD panel to have a wide viewing angle effect.

The invention provides a LCD panel including an active device array substrate, an opposite substrate, a liquid crystal layer, a plurality of first pixel electrodes, a plurality of second pixel electrodes and a light shielding layer. The active device array substrate has a plurality of active devices respectively corresponding to the plurality of pixel regions. The opposite substrate is disposed opposite to the active device array substrate. The liquid crystal layer having a plurality of positive liquid crystal molecules is disposed between the active device array substrate and the opposite substrate. The light shielding layer is disposed between the active device array substrate and the opposite substrate, in which the light shielding layer includes a plurality of opening regions respectively corresponding to the plurality of pixel regions. The first pixel electrodes are disposed on the active device array substrate and respectively located in the plurality of pixel regions, in which each of the first pixel electrodes is electrically connected to the corresponding active device, and each of the first pixel electrodes includes a plurality of strip first pixel electrode patterns. The second pixel electrodes are disposed on the active device array substrate and respectively located in the plurality of pixel regions, in which each of the second pixel electrodes includes a plurality of strip second pixel electrode patterns. The strip first pixel electrodes and the strip second pixel electrode patterns are alternately arranged. Each of the opening regions includes a plurality of sub regions, and each of the strip first pixel electrode patterns and its neighboring strip second pixel electrode pattern in each of the sub regions are separated from each other by an electrode spacing, the electrode spacings between the strip first pixel electrode patterns and the strip second pixel electrode patterns in different sub regions have sizes different from each other, in which each of the opening regions has an area of all the sub regions with the size of the electrode spacings less than or equal to 12 micrometers accounted for less than or equal to 35% area of the opening region, and an area of all the sub regions with the size of the electrode spacings greater than 12 micrometers accounted for more than or equal to 65% area of the opening region.

According to an embodiment of the invention, each of the opening regions has an area of all the sub regions with the size of the electrode spacings less than or equal to 12 micrometers accounted for 5% to 30% area of the opening region, and an area of all the sub regions with the size of the electrode spacings greater than 12 micrometers accounted for 95% to 70% area of the opening region.

According to an embodiment of the present invention, the first pixel electrodes and the second pixel electrodes are located between the active device array substrate and the liquid crystal layer.

According to an embodiment of the present invention, the first pixel electrodes and the second pixel electrodes are located on a same plane above the active device array substrate.

According to an embodiment of the present invention, the size of the electrode spacing between the first pixel electrode pattern and the second pixel electrode pattern in each of the opening regions is ranged between 4 micrometers to 16 micrometers.

According to an embodiment of the present invention, the first pixel electrode patterns and the second pixel electrode patterns in each of the opening regions are provided with 2 to 6 kinds of electrode spacings.

According to an embodiment of the invention, each of the opening regions is provided with 2 kinds of electrodes spacings, an area of all the sub regions with the size of the electrode spacings less than or equal to 12 micrometers accounted for 5% to 25% area of the opening region, and an area of all the sub regions with the size of the electrode spacings greater than 12 micrometers accounted for 95% to 75% area of the opening region.

According to an embodiment of the invention, in each of the opening regions, all sub regions with the electrode spacings less than or equal to 12 micrometers in size account for 10% to 30% area of the opening region and consist of two kinds of electrode spacings, and all sub regions with electrode spacings more than or equal to 12 micrometers in size account for 90% to 70% area of the opening region.

According to an embodiment of the invention, in each of the opening regions, all sub regions with the electrode spacings less than or equal to 12 micrometers in size account for 15% to 25% area of the opening region and have three kinds of electrode spacings, and all sub regions with electrode spacings more than or equal to 12 micrometers in size account for 85% to 75% area of the opening region.

According to an embodiment of the invention, in each of the opening regions, all sub regions with the electrode spacings less than or equal to 12 micrometers in size account for 20% to 25% area of the opening region and have four kinds of electrode spacings, and all sub regions with electrode spacings more than or equal to 12 micrometers in size account for 80% to 75% area of the opening region.

According to an embodiment of the invention, in each of the opening regions, all sub regions with the electrode spacings greater than 12 micrometers in size account for 90% to 75% area of the opening region and have two kinds of electrode spacings, and all sub regions with electrode spacings less than or equal to 12 micrometers in size account for 10% to 25% area of the opening region.

According to an embodiment of the present invention, each of the second pixel electrodes is electrically connected to the corresponding active device.

According to an embodiment of the present invention, each of the second pixel electrodes is electrically connected to a constant voltage.

According to an embodiment of the present invention, the LCD panel further includes a vertical alignment layer disposed between the liquid crystal layer and the active device array substrate or/and between the liquid crystal layer and the opposite substrate.

In view of above, according to the invention, the opening region is divided into a plurality of sub regions, and by modulating the electrode spacings and the area of each of the sub regions accounted for the opening region, the liquid crystal molecules in different position have different tilt angles. As a result, the LCD panel can achieve the wide viewing angle effect.

To make the above features and advantages of the invention more comprehensible, several embodiments accompanied with drawings are described in detail as follows.

### BRIEF DESCRIPTION OF THE DRAWINGS

FIG. 1A is a schematic cross-sectional view of a liquid crystal display (LCD) panel according to an embodiment of the invention.

FIG. 1B is a schematic top view of the LCD panel in FIG. 1A according to an embodiment of the invention.

FIG. 2A is a schematic top view of an active device array substrate in FIG. 1A.

FIG. 2B is a schematic top view of the active device array substrate in FIG. 1A according to another embodiment of the invention.

FIG. 2C is a schematic top view of the active device array substrate in FIG. 1A according to yet another embodiment of the invention.

FIGS. 3A and 3B are schematic enlarged views illustrating the opening regions in FIG. 2 in different embodiments.

FIGS. 4A and 4B are schematic cross-sectional views taken along a sectioning line A-A′ in FIG. 3A.

FIGS. 5 to 7 are grey level-transmittance curve diagrams corresponding to electrode spacings/areas ratio under using of 2 to 6 electrode spacings.

### DESCRIPTION OF THE EMBODIMENTS

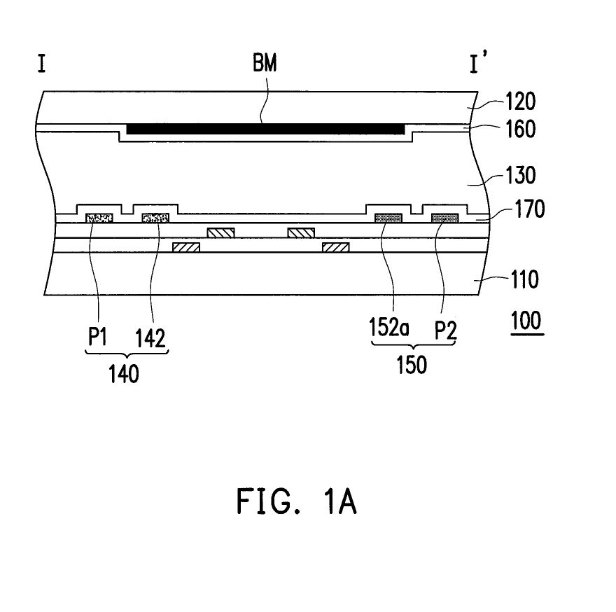

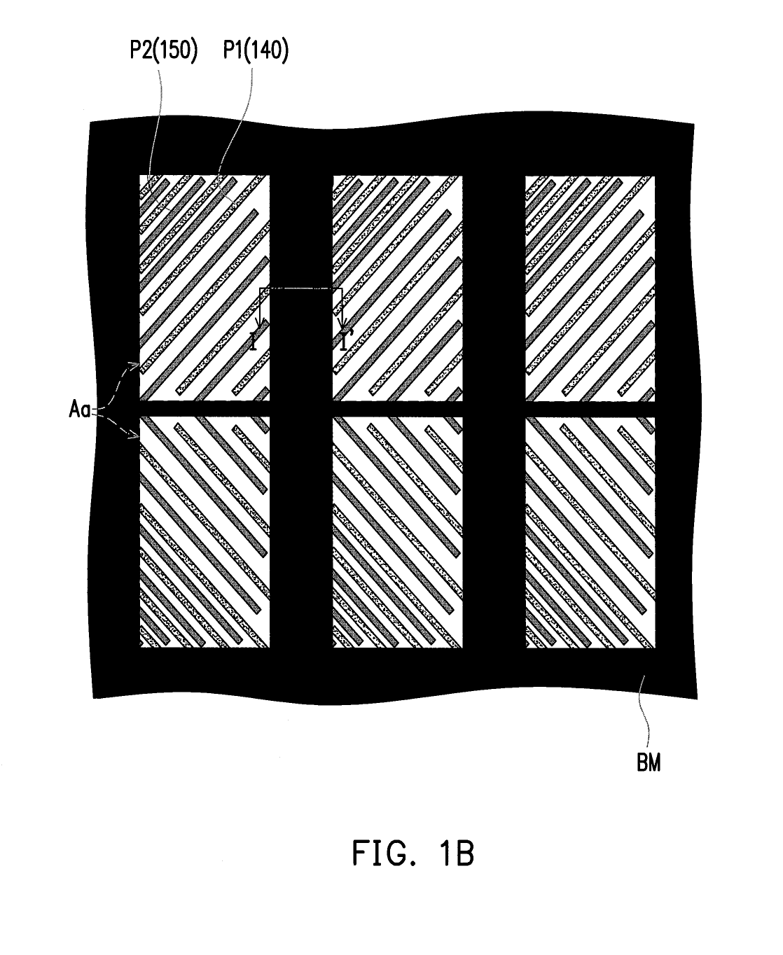

FIG. 1A is a schematic cross-sectional view of a liquid crystal display (LCD) panel according to an embodiment of the invention. FIG. 1B is a schematic top view of the LCD panel in FIG. 1A according to an embodiment of the invention, in which FIG. 1A is a schematic cross-sectional view illustrating an active device array substrate and layers thereon taken along the sectioning line I-I′ of FIG. 1B. Further, in order to simplify the description, certain layers in FIG. 1B are partially omitted.

Referring to FIG. 1A, a LCD panel 100 of the present embodiment includes an active device array substrate 110, an opposite substrate 120, a liquid crystal layer 130, a plurality of first pixel electrodes 140, a plurality of second pixel electrodes 150 and a light shielding layer BM.

The opposite substrate 120 is disposed opposite to the active device array substrate 110, and the liquid crystal layer 130 is located between the active device array substrate 110 and the opposite substrate 120. The liquid crystal layer BM is disposed between the active device array substrate 110 and the opposite substrate 120. In the present embodiment, the liquid crystal layer BM is disposed on the opposite substrate 120, however, in other embodiments, the liquid crystal layer BM may also be disposed on the active device array substrate 110.

The first pixel electrodes 140 and the second pixel electrodes 150 are, for example, disposed between the active device array substrate 110 and the liquid crystal layer 130. More specifically, the first pixel electrodes 140 are disposed on the active device array substrate 110, and the second pixel electrode 150 are also disposed on the active device array substrate 110. In the present embodiment, the first pixel electrodes 140 and the second pixel electrodes 150 are, for example, located on a same plane above the active device array substrate 110. In addition, each of the first pixel electrodes 140 includes a plurality of strip first pixel electrode patterns P1, and each of the second pixel electrodes 150 includes a plurality of strip second pixel electrode patterns P2.

FIG. 1B illustrates disposition relations between the strip first pixel electrode patterns P1, the strip second pixel electrode patterns P2 and the light shielding layer BM. Referring to FIG. 1B, the light shielding layer BM has a plurality of opening region Aa, exposing the strip first pixel electrode patterns P1 and the strip second pixel electrode patterns P2, and the strip first pixel electrode patterns P1 and the strip second pixel electrode patterns P2 are alternately arranged in the opening region Aa.

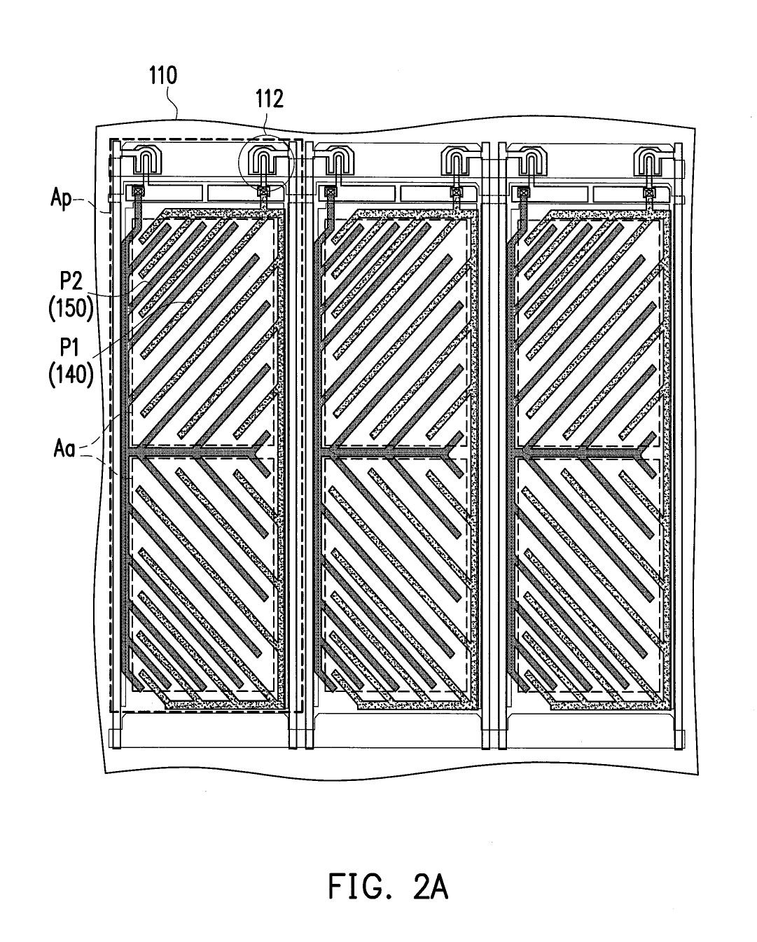

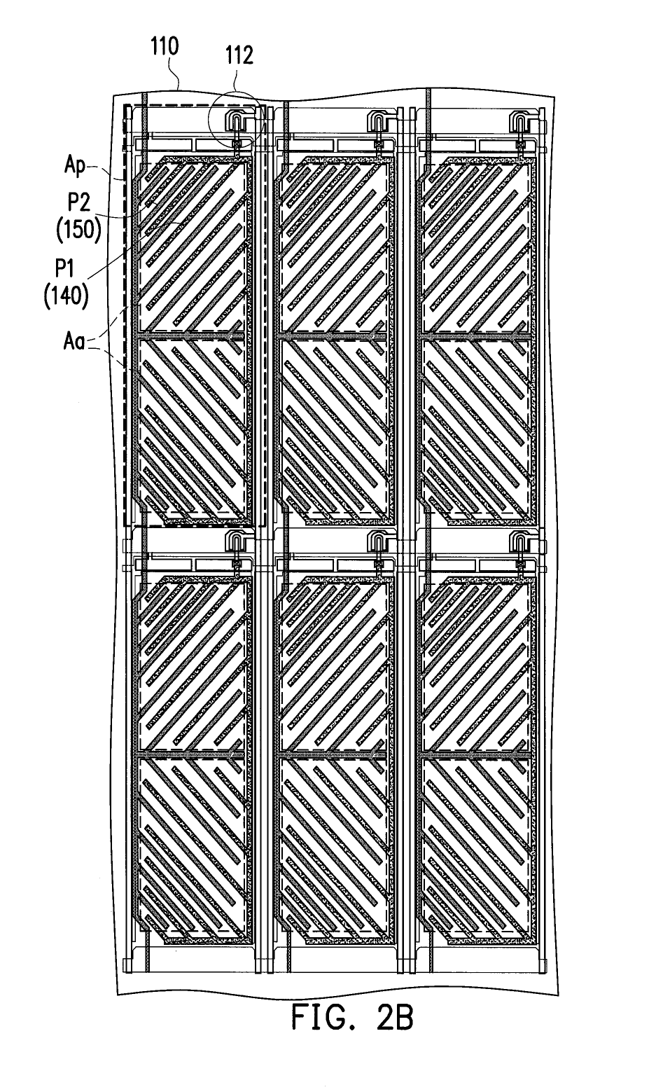

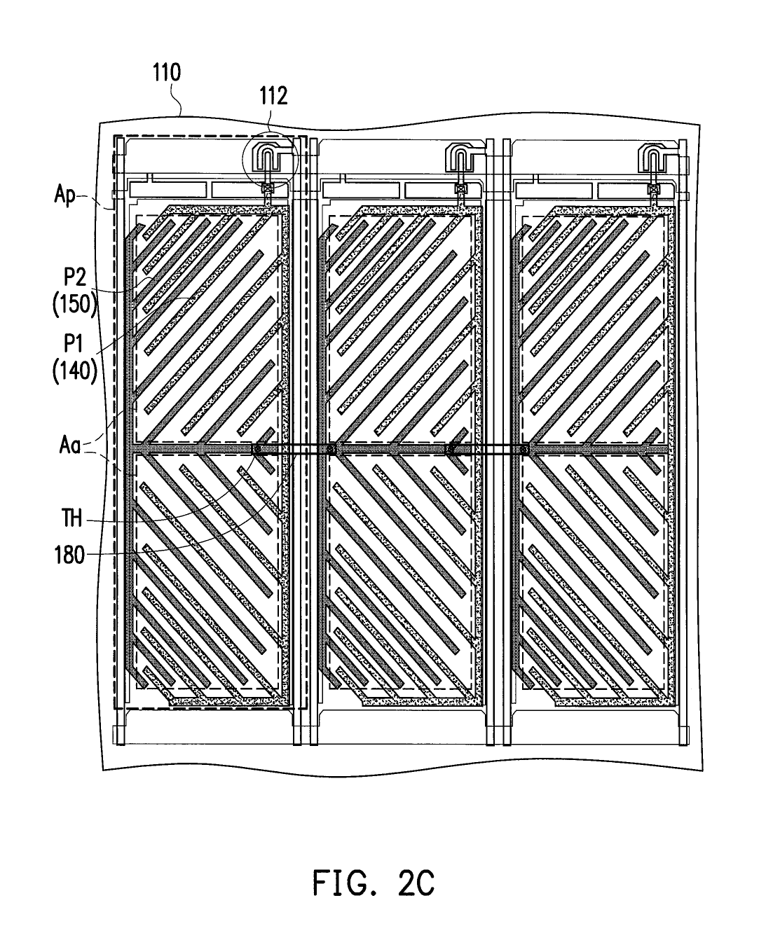

FIG. 2A is a schematic top view of the active device array substrate 110 in FIG. 1A. Referring to FIGS. 1A, 1B and 2A, the LCD panel 100 of the present embodiment includes a plurality of pixel regions Ap, and the active device array substrate 110 includes a plurality of active devices 112 respectively corresponding to the pixel regions Ap. In addition, the first pixel electrodes 140 and the second pixel electrodes 150 are respectively located in the pixel regions Ap. In addition, the light shielding layer BM of the present embodiment covers, for example, a region in each of pixel regions Ap without disposed with the strip first pixel electrode patterns P1 and the strip second pixel electrode patterns P2. That is, the strip first pixel electrode patterns P1 and the strip second pixel electrode patterns P2 are in the opening regions Aa of the light shielding layer BM.

It should be noted that, although the pixel region Ap of the present embodiment is only illustrated with two active devices (which are electrically connected to the first pixel electrodes 140 and the second pixel electrodes 150, respectively), but the invention is not limited thereto. In other embodiments, the second pixel electrodes 150 may also be connected to a constant voltage. As shown in FIG. 2B, the second pixel electrodes 150 may be connected to the constant voltage by connecting the second pixel electrodes 150 in two adjacent pixel regions Ap to each other. It should be noted that in the present embodiment, an insulating layer may be disposed between the first pixel electrodes 140 and the second pixel electrodes 150. According to another embodiment, as shown in FIG. 2C, two adjacent pixel regions Ap may be connected to each other through a metal connecting wire 180, in which the second pixel electrodes 150 may be electrically connected to the metal connecting wire 180 via a contact hole TH. Accordingly, the second pixel electrodes 150 may then be connected to the constant voltage.

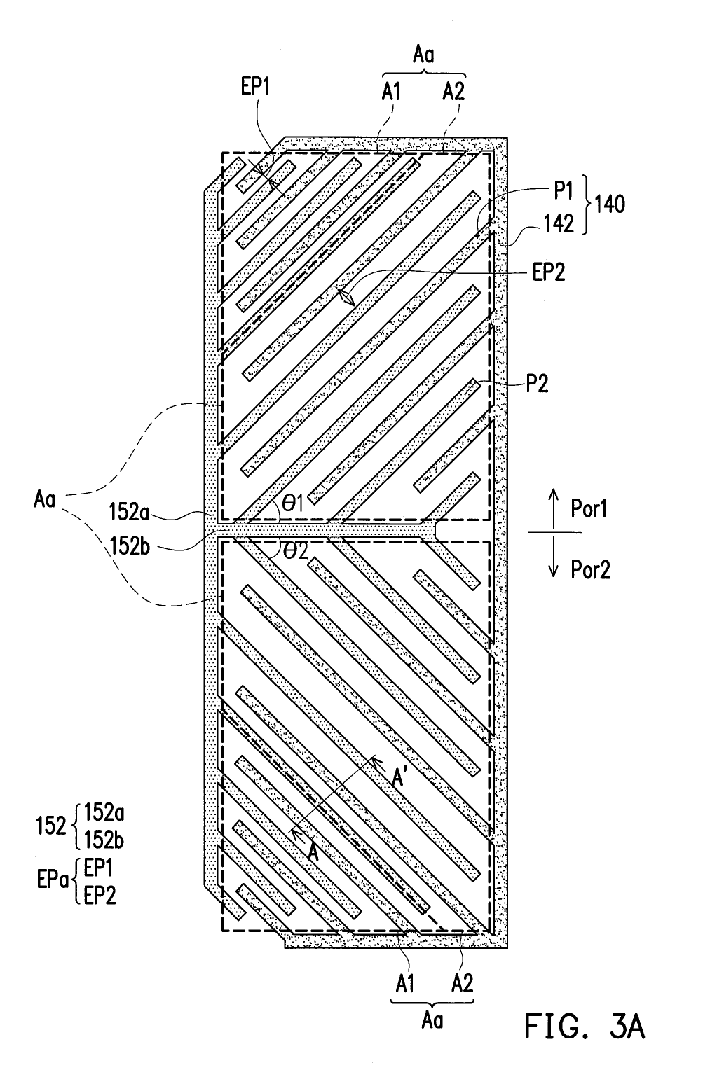

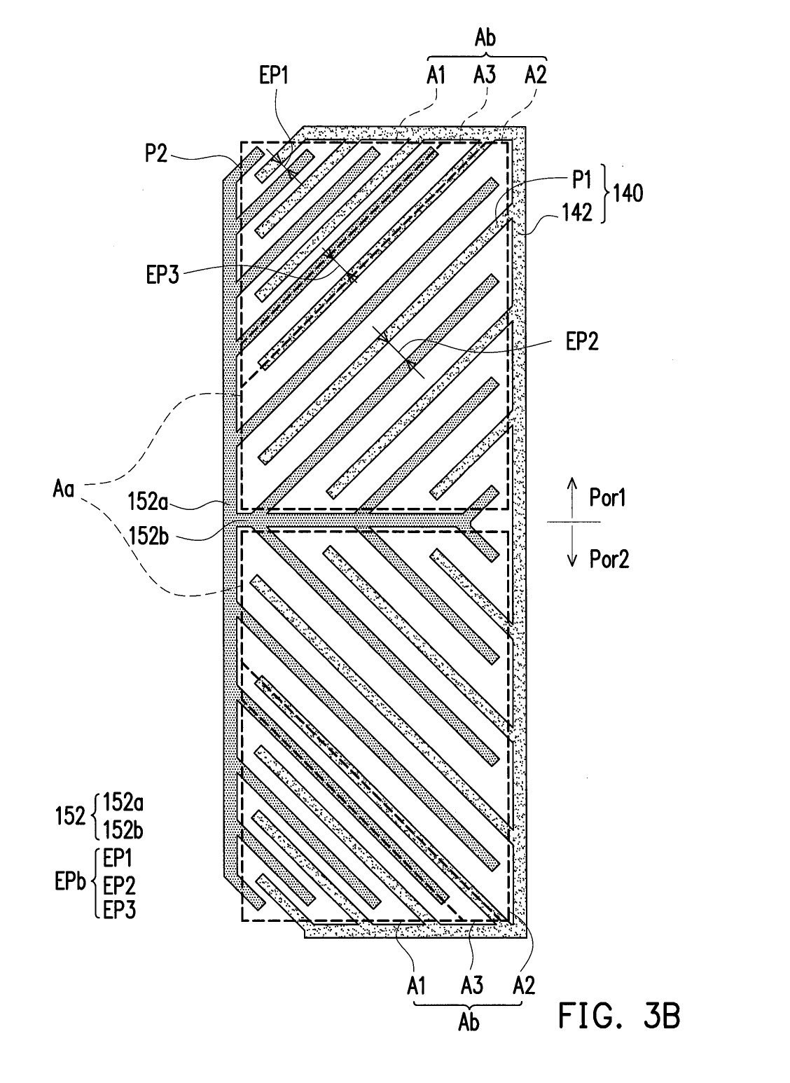

FIGS. 3A and 3B are schematic enlarged views illustrating the opening regions Aa of FIG. 2A in different embodiments. Referring to FIG. 3A, in the present embodiment, the first pixel electrode 140 may further include a first connecting pixel electrode 142, and the second pixel electrode 150 may further include a second connecting pixel electrode 152. In the present embodiment, a shape of the second connecting pixel electrode 152 may be, for example, a T-shape, the T-shape may be divided into a first connecting portion 152a and a second connecting portion 152b connected to the first connecting portion 152a, in which the first connecting portion 152a and the first connecting pixel electrode 142 are located around the opening regions Aa, thereby defining an area outline of the opening region Aa. In the present embodiment, the light shielding layer BM (as illustrated in FIG. 1B) covers the first connecting pixel electrode 142 and the second connecting pixel electrode 152, such that the area of the opening regions Aa does not include the first connecting pixel electrode 142 and the second connecting pixel electrode 152.

More specifically, the first connecting portion 152a is located on one side of the opening region Aa, and the first connecting pixel electrode 142 is located on three remaining sides of the opening region Aa. In the present embodiment, the first connecting portion 152a is, for example, located on a long side of the opening region Aa, and the first connecting pixel electrode 142 is, for example, located on another long side opposite to the said long side and two short sides connected to said long side, but the invention is not limited thereto.

In addition, the second connecting portion 152b is, for example, extended along a direction from the first connecting portion 152a towards an opposite side where the first connecting pixel electrode 142 is located. In the present embodiment, the second connecting portion 152b divides the opening region Aa of the pixel region Ap into a first portion Por1 and a second portion Por2 by, for example, crossing a middle line of the opening region Aa, and electrode patterns of the first portion Por1 and the second portion Por2 (referring to the strip first pixel electrode patterns P1 and the strip second pattern pixel electrode patterns P2) are, for example, symmetrically arranged.

More specifically, each of the strip first pixel electrode patterns P1 is extended along a direction from the first connecting pixel electrode 142 towards the second connecting pixel electrode 152 (including the first connecting portion 152a and the second connecting portion 152b), each of the strip second pixel electrode patterns P2 is extended along a direction from the second connecting pixel electrode 152 towards the first connecting pixel electrode 142, and the strip first pixel electrode patterns P1 and the strip second pixel electrode patterns P2 of the first portion Por1, for example, both form a first included angle θ1 together with the second connecting portion 152b. In the present embodiment, the first included angle θ1 is, for example, 90 degrees. In addition, the strip first pixel electrode patterns P1 and the strip second pixel electrode patterns P2 of the second portion Por2, for example, both from a second included angle θ2 together with the second connecting portion 152b, wherein an absolute value of the first angle θ1 is substantially identical to an absolute value of the second angle θ2, and the only difference between the first included angle θ1 and the second included angle θ2 is a negative sign.

It should be noted that in the present embodiment, the strip first pixel electrode pattern P1 and the strip second pixel electrode pattern P2 of the first portion Por1 are illustrated as being arranged from lower-left to upper-right, whereas the strip first pixel electrode pattern P1 and the strip second pixel electrode pattern P2 of the second portion Por2 are illustrated as being arranged from upper-left to lower-right. However, pattern arranged by the strip first pixel electrode pattern P1 and the strip second pixel electrode pattern P2 are not particularly limited by the invention.

For instance, in other embodiments, an arrangement of the strip first pixel electrode pattern P1 and the strip second pixel electrode pattern P2 of the first portion Por1 and an arrangement of the strip first pixel electrode pattern P1 and the strip second pixel electrode pattern P2 of the second portion Por2 may be exchanged. In other words, the strip first pixel electrode pattern P1 and the strip second pixel electrode pattern P2 of the first portion Por1 may be arranged from upper-left to lower-right, whereas the strip first pixel electrode pattern P1 and the strip second pixel electrode pattern P2 of the second portion Por2 may be arranged from lower-left to upper-right. Alternatively, the shape of the second connecting pixel electrode 152 may be a cross-shape arranged in the opening region Aa, the first connecting pixel electrode 142 may be circularly disposed around the opening region Aa, and the strip second pixel electrode pattern P2 is extended from the second connecting pixel electrode 152 towards a periphery of the opening region Aa (i.e., extending along a direction towards the first connecting pixel electrode 142), and the strip first pixel electrode pattern P1 is extended along a direction from the first connecting pixel electrode 142 towards the second connecting pixel electrode 152.

It should be noted that in the present embodiment, since the electrode patterns of the first portion Por1 and the second portion Por2 are symmetrically arranged, liquid crystal molecules located in the first portion Por1 and the second portion Por2 may tilt at different directions, so as to achieve a wide viewing angle effect in multi-domain. As a result, the LCD panel of the present embodiment may achieve the wide viewing angle effect.

The opening region Aa includes a plurality of sub regions A1 and A2. The strip first pixel electrode pattern P1 is separated from the neighboring strip second pixel electrode pattern P2 in each of the sub regions A1 and A2 by an electrode spacing EPa, and the strip first pixel electrode patterns P1 and the strip second pixel electrode patterns P2 in different sub regions A1 and A2 have different sizes of the electrode spacings EPa (respectively marked as EP1 and EP2). In addition, a size of the electrode spacing EPa between the strip first pixel electrode pattern P1 and the neighboring strip second pixel electrode pixel P2 is, for example, between 4 micrometers to 16 micrometers, and the strip first pixel electrode pattern P1 and the strip second pixel electrode pattern P2 are provided with 2 to 6 kinds of electrode spacings. In addition, an area of all the sub regions with the size of the electrode spacings EPa less than or equal to 12 micrometers accounts for less than or equal to 35% (including 0%) area of the opening region Aa, and an area of all the sub regions with the size of the electrode spacings EPa greater than 12 micrometers (not including 12 micrometers) accounts for greater than or equal to 65% (including 100%) area of the opening region Aa.

In the present embodiment, the opening region Aa is illustrated by using two sub regions A1 and A2 with 2 kinds of electrode spacings (EP1 and EP2), but the invention is not limited thereto. More specifically, in the present embodiment, the size of the electrode spacing EP1 of the sub region A1 is, for example, less than or equal to 12 micrometers, and the size of the electrode spacing EP2 of the sub region A2 is, for example, greater than 12 micrometers; and an area of the sub region A1 accounts for 5% to 25% area of the opening region Aa, and an area of the sub region A2 accounts for 95% to 75% area of the opening region Aa. More specifically, the area of the sub region A1 and the area of the sub region A2 are complementary. In other words, a summation of the area of the sub region A1 and the area of the sub region A2 is equal to the area of the opening region Aa.

Referring to FIG. 3B, the opening region Ab of the present embodiment has a similar structure to that of the opening region Aa illustrated in FIG. 3A. The major difference between the two lies where the opening region Ab of the present embodiment has three sub regions A1, A2 and A3, and the strip first pixel electrode pattern P1 and the strip second pixel electrode pattern P2 in each of the opening regions Ab are provided with 3 kinds of electrode spacings EPb (including EP1, EP2 and EP3). More specifically, in each of opening regions Ab, all the sub regions with the size of the electrode spacing EPb less than or equal to 12 micrometer (including the sub regions A1 and A3) have two kinds of electrode spacings EP1 and EP3, and an area of said sub regions A1 and A3 accounts for 10% to 30% area of the opening region Ab, and an area of the sub region with the electrode spacing EPb greater than 12 micrometer (referring to the sub regions A2) accounts for 90% to 70% area of the opening region Ab.

It should be noted that, in the embodiments of FIGS. 3A and 3B, the sizes of the electrode spacings are illustrated in a configuration of gradually increased from outside to inside (or from upper-left and lower-left to middle-right), but the invention is not limited thereto. Such configuration is merely used for illustrating the area of the opening regions having different electrode spacings accounted for the area of the sub region. In other embodiments, the sizes of the electrode spacings may also be illustrated in a configuration of gradually decreased from outside to inside, or in an irregular configuration. However, in the case where the amount of kinds of the electrode spacing included between the strip first pixel electrode pattern P1 and the strip second pixel electrode pattern P2 being 4, 5, or 6, the patterns may be arranged the same to above-said configurations, so it is omitted hereinafter.

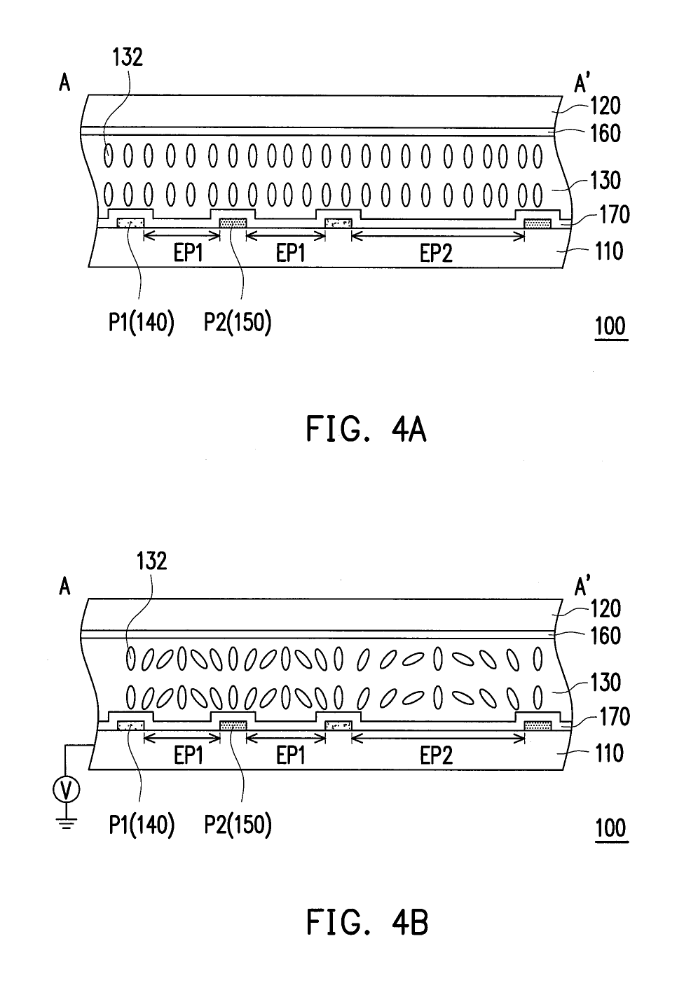

FIGS. 4A and 4B are schematic cross-sectional views taken along a sectioning line A-A′ in FIG. 3A. In which the active device array substrate 110 and the opposite substrate 120 of FIG. 1 are further illustrated in FIGS. 4A and 4B, so as to explain a driving method of the LCD panel. Referring FIGS. 4A and 4B, the LCD panel 100 of the present embodiment is illustrated by using a Vertical Alignment In-Plane Switching (VAIPS) LCD panel.

More specifically, the liquid crystal layer 130 may, for example, include a plurality of positive liquid crystal molecules 132. In addition, the LCD panel 100 may further include vertical alignment layers disposed on at least one side of the liquid crystal layer 130, so as to provide an anchoring force thereto. In an embodiment, the LCD panel 100, for example, includes vertical alignment layers 160 and 170 respectively disposed between the liquid crystal layer 130 and the opposite substrate 120 and between the liquid crystal layer 130 and the active device array substrate 110, but the invention is not limited thereto.

In addition, the strip first pixel electrode pattern P1 and the strip second pixel electrode pattern P2 are disposed on a same plane and located on the same side of the liquid crystal layer 130.

When no voltage is applied (as shown in FIG. 4A), the positive liquid crystal molecules 132 are vertically arranged (i.e., a long axis of the positive liquid crystal molecules 132 that is perpendicular to the active device array substrate 110 or the opposite substrate 120). On the other hand, when a voltage V is applied, a horizontal electric field which is parallel to a direction of the active device array substrate 110 or a direction of the opposite substrate 120 may be generated between the strip first pixel electrode pattern P1 and the strip second pixel electrode pattern P2 on the same plane, thereby driving the positive liquid crystal molecules 132 to tilt along a direction of the electric field.

Since a slope of tangent line (or the direction of the electric field) of a power line between the strip first pixel electrode pattern P1 and the neighboring strip second pixel electrode pattern P2 may vary according to their changes in the position, thus the positive liquid crystal molecules 132 in different position may have different tilt angles. For instance, the slope of tangent line of the power line is greater (e.g., approaching 90 degrees) while closing to either one of two electrodes (referring to the strip first pixel electrode pattern P1 and the strip second pixel electrode pattern P2), such that the positive liquid crystal molecule 132 closing to either one of two electrodes may tilt along a wide angle (i.e., an included angle between the positive liquid crystal molecule 132 and the active device array substrate 110 is approaching 90 degrees). On the other hand, the slope of tangent line of the power line is smaller (e.g., approaching 0 degree) while closing to a middle point of two electrodes, such that the positive liquid crystal molecule 132 closing to a middle point of two electrodes may tilt along an angle closed to the horizontal line (i.e., an included angle between the positive liquid crystal molecule 132 and the active device array substrate 110 is approaching 0 degree). Since tilt angles of the positive liquid crystal molecules 132 between two adjacent electrodes (referring to the strip first pixel electrode pattern P1 and the strip second pixel electrode pattern P2) are symmetrically arranged, the present embodiment provides electrodes with different tilting designs so as to allow the LCD panel 100 to have the wide viewing angle effect.

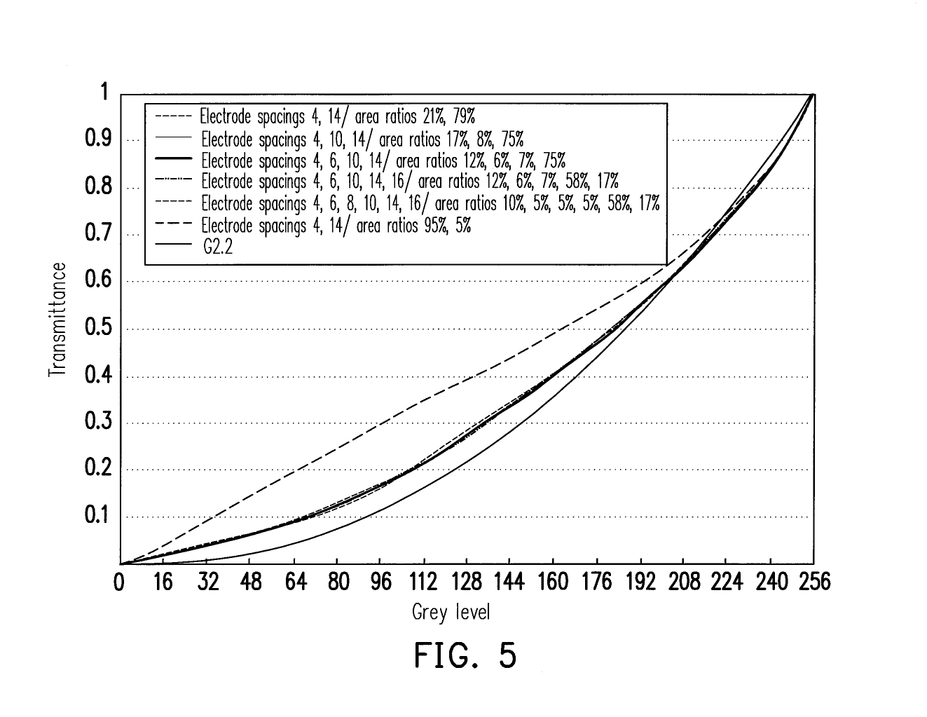

In addition, by modulating an amount of the electrode spacings, a size of the electrode spacing and an area of each of the sub regions accounted for area of the each of the opening regions, (hereinafter, the “area ratio”) in each of the sub regions in the present embodiment, the problems associated with the color shift and the color washout when watching from off-axis viewing angle may be further improved. Influences of different sizes of the electrode spacings (unit: micrometer) and different area ratios (unit: %) to displaying effects with different amounts of the electrode spacings are illustrated in Tables 1 to 3 below with reference to FIGS. 5 to 7.

FIGS. 5 to 7 are grey level-transmittance curve diagrams corresponding to the sizes of the electrode spacings/the area ratios under using of 2 to 6 electrode spacings. According to curves in FIGS. 5 to 7, in which a curve G2.2 represents a curve having gamma value of 2.2, and the closer the curve is to the curve G2.2 indicates a better displaying effect.

Table 1 exhibits influences of the sizes of the electrode spacings and the area ratios to D value under using of 2 to 6 kinds of electrode spacings. The definition of D value is as described above, so it is omitted hereinafter.

TABLE 1

| | Electrode | Electrode | Electrode | Electrode | Electrode | Electrode | |
|---|---|---|---|---|---|---|---|
| Kinds of | spacing | spacing | spacing | spacing | spacing | spacing | |
| electrode | (μm)/area | (μm)/area | (μm)/area | (μm)/area | (μm)/area | (μm)/area | |
| spacings | ratio (%) | ratio (%) | ratio (%) | ratio (%) | ratio (%) | ratio (%) | D value |
| 2 | 4/21 | 14/79 | X | X | X | X | 0.234 |
| 3 | 4/17 | 10/8 | 14/75 | X | X | X | 0.225 |
| 4 | 4/12 | 6/6 | 10/7 | 14/75 | X | X | 0.224 |
| 5 | 4/12 | 6/6 | 10/7 | 14/58 | 16/17 | X | 0.224 |
| 6 | 4/10 | 6/5 | 8/5 | 10/5 | 14/58 | 16/17 | 0.225 |

As shown in FIG. 5 and Table 1, besides a simulated curve with a configuration of “electrode spacings 4, 14/area ratios 95%, 5%” is diverged from the curve G2.2, the rest of simulated curves with specific electrodes designs (including different amounts of the electrode spacings, different sizes of the electrode spacings and the area of each of the sub regions with different electrode spacings) in Table 1 are all approaching the curve G2.2, and the electrodes designs in Table 1 all have a rather small D value. In other words, the electrode designs as shown in Table 1 may all exhibit favorable displaying effects.

Table 2 exhibits influences of the sizes of the electrode spacings and the area ratios to Oblique Local Gamma Distortion (OLGD) value under using of 2 to 6 kinds of electrode spacings. The definition of OLGD value is as described above, so it is omitted hereinafter.

TABLE 2

| | Electrode | Electrode | Electrode | Electrode | Electrode | Electrode | Oblique |
|---|---|---|---|---|---|---|---|
| Kinds of | spacing | spacing | spacing | spacing | spacing | spacing | Local |
| electrode | (μm)/area | (μm)/area | (μm)/area | (μm)/area | (μm)/area | (μm)/area | Gamma |
| spacings | ratio (%) | ratio (%) | ratio (%) | ratio (%) | ratio (%) | ratio (%) | Distortion |
| 2 | 4/8 | 14/92 | X | X | X | X | 1.031 |
| 3 | 4/7 | 10/5 | 14/88 | X | X | X | 0.798 |
| 4 | 4/6 | 10/5 | 14/35 | 16/54 | X | X | 0.759 |
| 5 | 4/6 | 10/5 | 12/5 | 14/25 | 16/59 | X | 0.764 |
| 6 | 4/5 | 6/5 | 10/5 | 12/5 | 14/19 | 16/61 | 0.765 |

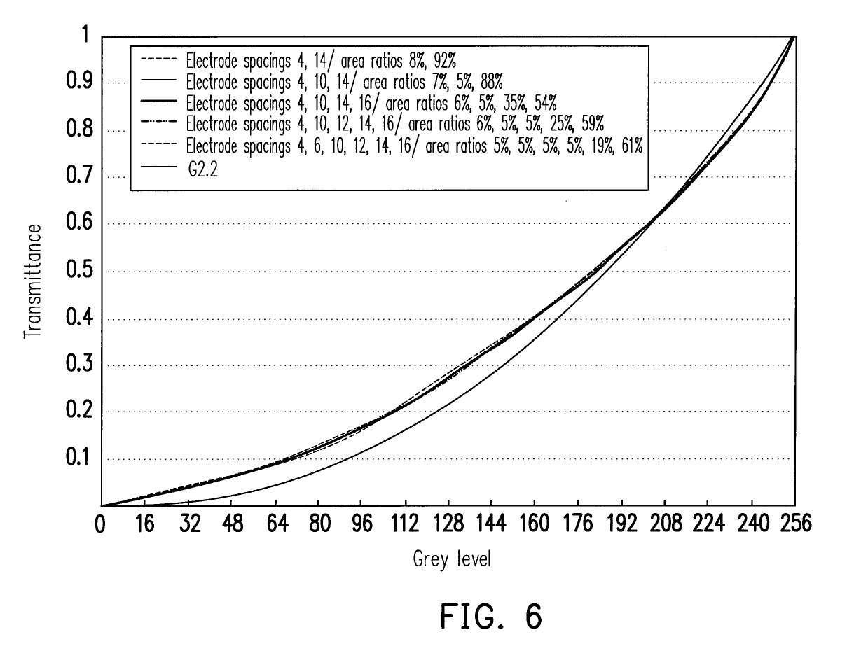

As shown in FIG. 6 and Table 2, in which simulated curves with specific electrodes designs (including different amounts of the electrode spacings, different sizes of the electrode spacings and the area of each of the sub regions with different electrode spacings) in Table 2 are all approaching the curve G2.2 and the electrodes designs in Table 2 all have a rather small OLGD value. In other words, the electrode designs as shown in Table 2 may all exhibit favorable displaying effects.

Table 3 exhibits influences of the sizes of the electrode spacings and the area ratios to Tone Rendering Distortion Index (TRDI) value under using of 2 to 6 kinds of electrode spacings. Herein, TRDI value indicates not only a difference between an original image and a distorted image, but also an image quality of the distorted image.

TABLE 3

| | Electrode | Electrode | Electrode | Electrode | Electrode | Electrode | Tone |
|---|---|---|---|---|---|---|---|
| Kinds of | spacing | spacing | spacing | spacing | spacing | spacing | Rendering |
| electrode | (μm)/area | (μm)/area | (μm)/area | (μm)/area | (μm)/area | (μm)/area | Distortion |
| spacings | ratio (%) | ratio (%) | ratio (%) | ratio (%) | ratio (%) | ratio (%) | Index |
| 2 | 4/12 | 14/88 | X | X | X | X | 0.167 |
| 3 | 4/8 | 10/5 | 16/87 | X | X | X | 0.165 |
| 4 | 4/9 | 10/5 | 14/43 | 16/43 | X | X | 0.165 |
| 5 | 4/6 | 6/5 | 10/5 | 14/43 | 16/41 | X | 0.167 |
| 6 | 4/6 | 6/5 | 10/5 | 12/5 | 14/39 | 16/40 | 0.171 |

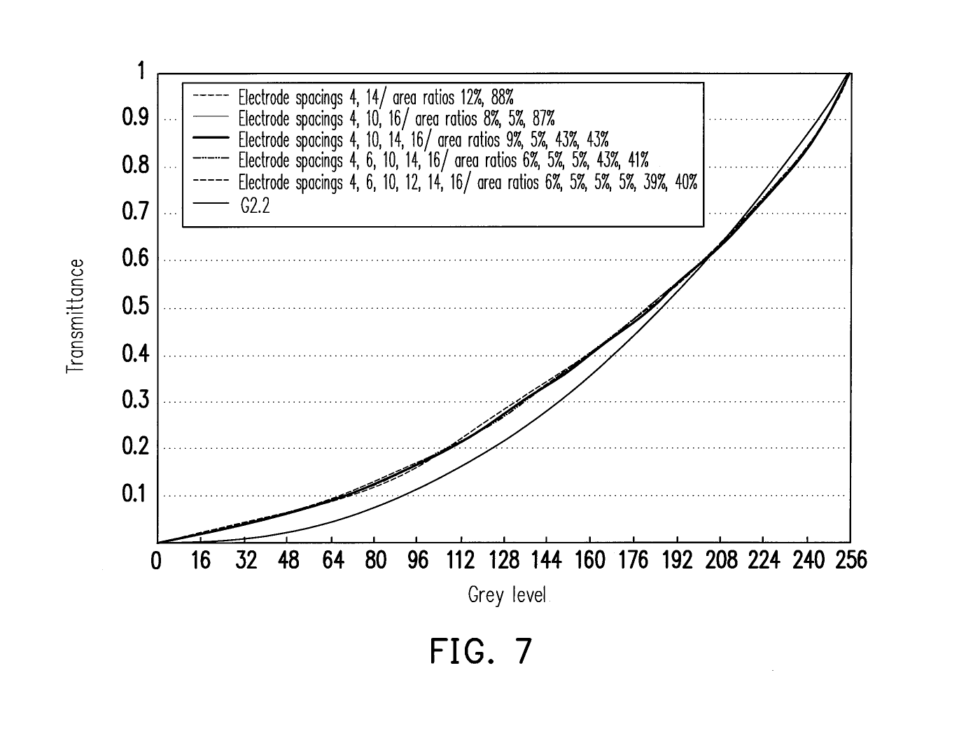

As shown in FIG. 7 and Table 3, in which simulated curves with specific electrodes designs (including different amounts of the electrode spacings, different sizes of the electrode spacings and the area of each of the sub regions with different electrode spacings) are all approaching the curve 2.2, and the electrodes designs in Table 3 all have a favorable TRDI value. In other words, the electrode designs as shown in Table 3 may all exhibit favorable displaying effects.

Referring to Tables 1 to 3 and FIGS. 5 to 7, it can be know that:

(1) In the case where the amount of kinds of the electrode spacings in each of the opening regions is 2, each of the opening regions has an area of all the sub regions with the size of the electrode spacings less than or equal to 12 micrometers accounted for 5% to 25% area of the opening region, and an area of all the sub regions with the size of the electrode spacings greater than 12 micrometers accounted for 95% to 75% area of the opening region.

(2) In each of the opening regions, all sub regions with the electrode spacings less than or equal to 12 micrometers in size consist of two kinds of electrode spacings and account for 10% to 30% area of the opening region, and all sub regions with electrode spacings more than or equal to 12 micrometers in size account for 90% to 70% area of the opening region.

(3) In each of the opening regions, all sub regions with the electrode spacings less than or equal to 12 micrometers in size have three kinds of electrode spacings and account for 15% to 25% area of the opening region, and all sub regions with electrode spacings more than or equal to 12 micrometers in size account for 85% to 75% area of the opening region

(4) In each of the opening regions, all sub regions with the electrode spacings less than or equal to 12 micrometers in size have four kinds of electrode spacings and account for 20% to 25% area of the opening region, and all sub regions with electrode spacings more than or equal to 12 micrometers in size account for 80% to 75% area of the opening region.

(5) In each of the opening regions, all sub regions with the electrode spacings greater than 12 micrometers in size have two kinds of electrode spacings and account for 90% to 75% area of the opening region, and all sub regions with electrode spacings less than or equal to 12 micrometers in size account for 10% to 25% area of the opening region.

Under using of above said 5 electrode designs, the LCD panel may have favorable displaying effects (i.e., the LCD panel may have a smaller D value, a smaller OLGD value and a more preferable TRDI value). Moreover, a more preferable electrode design of the present embodiment may be generalized in view of above said five features: each of the opening regions has an area of all the sub regions with the size of the electrode spacings less than or equal to 12 micrometers accounts for less than or equal to 35% area of the opening region, and an area of all the sub regions with the size of the electrode spacings greater than 12 micrometers accounts for more than or equal to 65% area of the opening region.

In view of above, according to the invention, the opening region is divided into a plurality of sub regions, and by modulating the sizes of the electrode spacings, amounts of the electrode spacings and the area of each of the sub regions accounted for the opening region, the liquid crystal molecules in different position may have different tilt angles. As a result, the LCD panel may achieve the wide viewing angle effect.

Although the invention has been described with reference to the above embodiments, it is apparent to one of the ordinary skill in the art that modifications to the described embodiments may be made without departing from the spirit of the invention. Accordingly, the scope of the invention will be defined by the attached claims not by the above detailed descriptions.

What is claimed is:

1. A liquid crystal display (LCD) panel having a plurality of pixel regions, the LCD panel comprises:
an active device array substrate having a plurality of active devices respectively corresponding to the plurality of pixel regions;
an opposite substrate disposed opposite to the active device array substrate;
a liquid crystal layer disposed between the active device array substrate and the opposite substrate, wherein the liquid crystal layer comprises a plurality of positive liquid crystal molecules;
a light shielding layer disposed between the active device array substrate and the opposite substrate, wherein the light shielding layer comprises a plurality of opening regions respectively corresponding to the plurality of pixel regions;
a plurality of first pixel electrodes disposed on the active device array substrate and respectively located in the plurality of pixel regions, wherein each of the first pixel electrodes is electrically connected to the corresponding active device, and each of the first pixel electrodes comprises a plurality of strip first pixel electrode patterns; and
a plurality of second pixel electrodes disposed on the active device array substrate and respectively located in the plurality of pixel regions, wherein each of the second pixel electrodes comprises a plurality of strip second pixel electrode patterns, and the plurality of strip first pixel electrode patterns and the plurality of strip second pixel electrode patterns are alternately arranged,
each of the opening regions comprising a plurality of sub regions, wherein each of the strip first pixel electrode patterns and its neighboring strip second pixel electrode pattern in each of the sub regions are separated from each other by an electrode spacing, the electrode spacings between the strip first pixel electrode patterns and the strip second pixel electrode patterns in different sub regions have sizes different from each other, an area of all the sub regions with the size of the electrode spacings less than or equal to 12 micrometers accounts for less than or equal to 35% area of the opening region, and an area of all the sub regions with the size of the electrode spacings greater than 12 micrometers accounts for more than or equal to 65% area of the opening region.

2. The LCD panel of claim 1, wherein each of the opening regions has the area of all the sub regions with the size of the electrode spacings less than or equal to 12 micrometers accounted for 5% to 30% area of the opening region, and the area of all the sub regions with the size of the electrode spacings greater than 12 micrometers accounted for 95% to 70% area of the opening region.

3. The LCD panel of claim 1, wherein the plurality of first pixel electrodes and the plurality of second pixel electrodes are located between the active device array substrate and the liquid crystal layer.

4. The LCD panel of claim 1, wherein the plurality of first pixel electrodes and the plurality of second pixel electrodes are located on a same plane above the active device array substrate.

5. The LCD panel of claim 1, wherein the size of the electrode spacing between the first pixel electrode pattern and the second pixel electrode pattern in each of the opening regions is ranged between 4 micrometers to 16 micrometers.

6. The LCD panel of claim 1, wherein the first pixel electrode patterns and the second pixel electrode patterns in each of the opening regions are provided with 2 to 6 kinds of electrode spacings.

7. The LCD panel of claim 1, wherein each of the opening regions is provided with 2 kinds of electrode spacings, the area of all the sub regions with the size of the electrode spacings less than or equal to 12 micrometers accounts for 5% to 25% area of the opening region, and the area of all the sub regions with the size of the electrode spacings greater than 12 micrometers accounts for 95% to 75% area of the opening region.

8. The LCD panel of claim 1, wherein in each of the opening regions, all sub regions with the electrode spacings less than or equal to 12 micrometers in size account for 10% to 30% area of the opening region and consist of two kinds of electrode spacings, and all sub regions with electrode spacings more than or equal to 12 micrometers in size account for 90% to 70% area of the opening region.

9. The LCD panel of claim 1, wherein in each of the opening regions, all sub regions with the electrode spacings less than or equal to 12 micrometers in size account for 15% to 25% area of the opening region and have three kinds of electrode spacings, and all sub regions with electrode spacings more than or equal to 12 micrometers in size account for 85% to 75% area of the opening region.

10. The LCD panel of claim 1, wherein in each of the opening regions, all sub regions with the electrode spacings less than or equal to 12 micrometers in size account for 20% to 25% area of the opening region and have four kinds of electrode spacings, and all sub regions with electrode spacings more than or equal to 12 micrometers in size account for 80% to 75% area of the opening region.

11. The LCD panel of claim 1, wherein in each of the opening regions, all sub regions with the electrode spacings greater than 12 micrometers in size account for 90% to 75% area of the opening region and have two kinds of electrode spacings, and all sub regions with electrode spacings less than or equal to 12 micrometers in size account for 10% to 25% area of the opening region.

12. The LCD panel of claim 1, wherein each of the second pixel electrodes is electrically connected to the corresponding active device.

13. The LCD panel of claim 1, wherein each of the second pixel electrodes is electrically connected to a constant voltage.

14. The LCD panel of claim 1, further comprising a vertical alignment layer disposed between the liquid crystal layer and the active device array substrate or between the liquid crystal layer and the opposite substrate.
